(19) United States
(12) Patent Application Publication
(10) Pub. No.: US 2013/0207378 A1
(43) Pub. Date: Aug. 15, 2013

(54) BALL JOINT FOR PIPE CONNECTION, AND PIPE CONNECTION

(71) Applicant: Marco Daniël Menheere, Bussum (NL)

(72) Inventor: Marco Daniël Menheere, Bussum (NL)

(73) Assignee: VOSTA LMG B.V., NN Amsterdam (NL)

(21) Appl. No.: 13/807,016

(22) PCT Filed: Jun. 27, 2011
(86) PCT No.: PCT/NL11/50462

§ 371 Date: Apr. 16, 2013

(30) Foreign Application Priority Data
Jun. 28, 2010 (NL) 2004985

(51) Int. Cl. F16L 27/06

(52) U.S. Cl. CPC F16L 27/06
USPC 285/55

(57) ABSTRACT

A ball joint (1) for a pipe connection includes shell parts (3, 4) surrounding one another in a sealing manner, which each define a respective longitudinal centre line and which are rotatable in relation to one another between an aligned position, in which the longitudinal centre lines coincide, and a rotated position, in which the longitudinal centre lines form an angle with one another which differs from zero. The shell parts together enclose an axial passage which extends between the connecting pieces or sleeves (20), (21) of the shell parts (3, 4) facing away from one another. In the outermost shell part (4), a lining (13) is provided, of which the inner lining surface (14) has a curvature corresponding to the curvature of the outer surface (5) of the inner shell part (3).

The invention relates to a ball joint for a pipe connection, comprising shell parts surrounding one another which each define a longitudinal centre line and which are rotatable in relation to one another between an aligned position, in which the longitudinal centre lines coincide, and a rotated position, in which the longitudinal centre lines form an angle with one another which differs from zero, wherein the inner surfaces of the shell parts together enclose an axial passage which extends between the connection pieces of the shell parts facing away from one another, and wherein a seal is provided on the inner surface of the outermost shell part.

A joint of this type for a pipe connection is known from GB-A-896836. In this known pipe connection, a truncated, conical seal is used, which is attached to the free ends of the outermost shell part. The seal lies with the inner surface thereof up against the outer surface of the innermost shell part. However, problems arise in the use of a pipe connection of this type for the transportation of a liquid with abrasive particles, such as dredging spoils. Depending on the rotated position of the shell parts in relation to one another, particles of this type may pass between the shell parts and onto the outer surface of the innermost shell part which must ensure the seal.

As a result, this surface may be subject to wear. The seal may also be subject to wear as a result of turbulence in the dredging spoils flowing through the pipe connection. The continuing intensive exposure to the abrasive components of the dredging spoils can adversely affect the surfaces of the seal to such an extent that the effect thereof is lost as soon as leaks can occur. This is caused above all by the fact that the outer surface of the inner shell part, along which the seal is displaceable, adjoins an open space in which the aforementioned turbulence is further increased.

The object of the invention is therefore to produce a ball joint of the aforementioned type which is more resistant to the effects of abrasive media. This object is achieved in that, in the outermost shell part, a lining is provided, of which the inner lining surface has a curvature corresponding to the curvature of the outer surface of the inner shell part.

In the ball joint according to the invention, a lining, which is attached to the outermost shell part, extends over the outer surface of the inner shell part. As a result, the space which the sensitive outer surface of the inner shell part adjoins is less readily accessible to the dredging spoils, to such an extent that turbulence and damaging effects of the abrasive particles present in the dredging spoils can be largely avoided. As a result, the surface condition of the outer surface of the innermost shell part can be held for a prolonged period in a position suitable for interworking with the seal. Leakages in the ball joint can thereby also be more effectively prevented.

This favourable effect of the lining can already be achieved if the lining surface and any outer surface of the inner shell part lie entirely free in relation to one another. Nevertheless, it is also possible for these surfaces to touch one another, although this is not necessary. In particular, the lining surface and the outer surface of the inner shell part can enclose a gap with an essentially uniform thickness.

The lining is connected to the outermost shell part, and may be displaced with the seal in relation to the innermost shell part. In this context, it is preferably provided that the seal comprises a sealing element connected to the outermost shell part and displaceably interworking with the outer surface of the innermost shell part, and the lining extends between the sealing element of the shell parts and the free end of the outermost shell part.

The lining surface is preferably essentially spherical. In this case, the lining can approach the innermost shell part as closely as possible. According to a further possibility, a flow guide can be provided in the innermost shell part. By means of a flow guide of this type, the dredging spoils flowing through the passage can be guided in such a way that the effect thereof on the integrity of the ball joint is further reduced. The flow guide preferably has a cylindrically and/or spherically curved inner flow guide surface for this purpose.

According to a further favourable design, the flow guide can extend beyond the end of the inner shell part which adjoins the lining. In particular, the flow guide can have a nozzle near the lining, which lies free in relation to the lining surface. This nozzle and the lining surface preferably enclose a gap, the size of which is essentially identical to the size of the gap between the lining surface and the outer surface of the inner shell part. The outer surface of that shell part can be further protected in relation to the flow by this nozzle which protrudes in relation to the innermost shell part. In particular, the flow guide may comprise a flow guide part which is located near to the outermost shell part and is designed as widening in the form of a cone or trumpet. As a result, the nozzle can closely follow the inner surface of the lining in every rotated position of the shell parts in relation to one another. The flow guide and the lining may comprise a plastic material.

The invention further relates to a pipe connection provided with a ball joint as described above, wherein the connection pieces of the shell parts of the ball joint facing away from one another each comprise a sleeve to which a respective pipe piece is attached, e.g. by welding. However, the connection between the pipe piece and the sleeve can be designed in any other way, for example by means of flanges which are attached to one another with bolts. A yoke can be attached in a known manner to the innermost shell part, said yoke being provided with a bush with an inner spherical surface which interworks in the manner of a ball and socket joint with an outer spherical surface of the outermost shell part.

The invention will be explained in detail below with reference to an example embodiment shown in the figures.

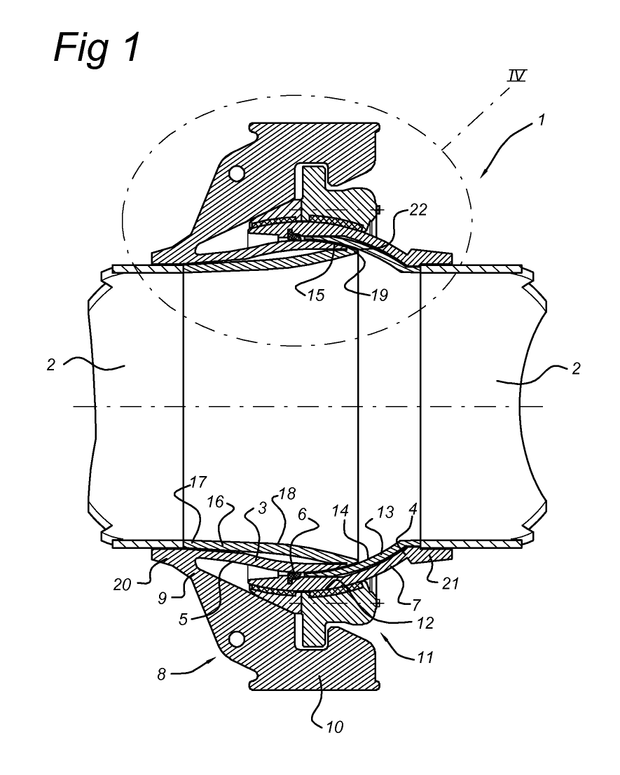

FIG. 1 shows a longitudinal cross-section of a pipe connection according to the invention in the aligned position.

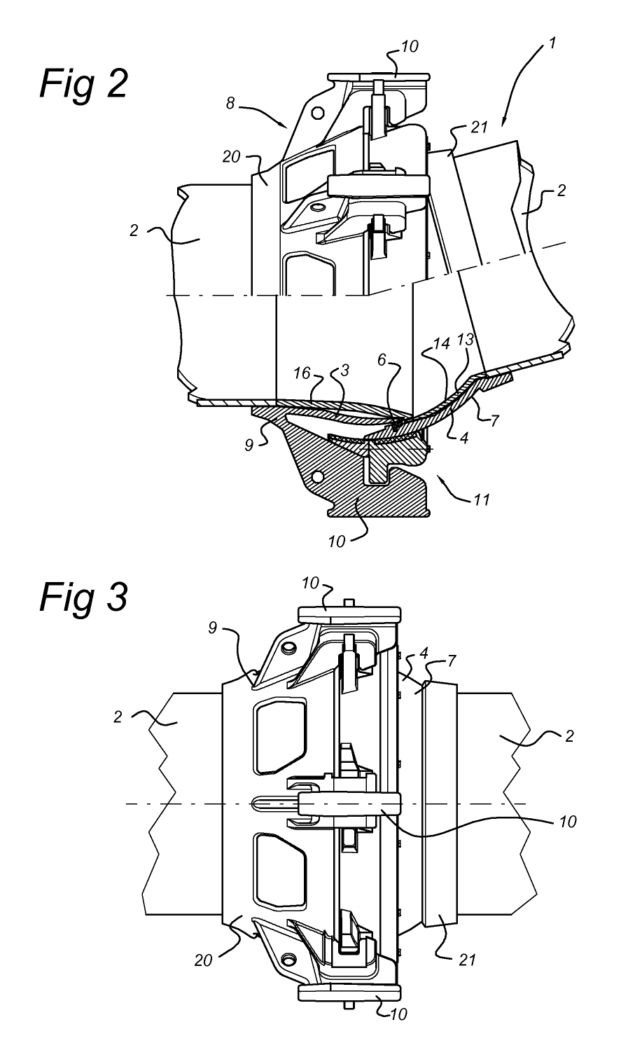

FIG. 2 shows a partial longitudinal cross-section of the pipe connection according to the invention in the curved position.

FIG. 3 shows an external view of the pipe connection.

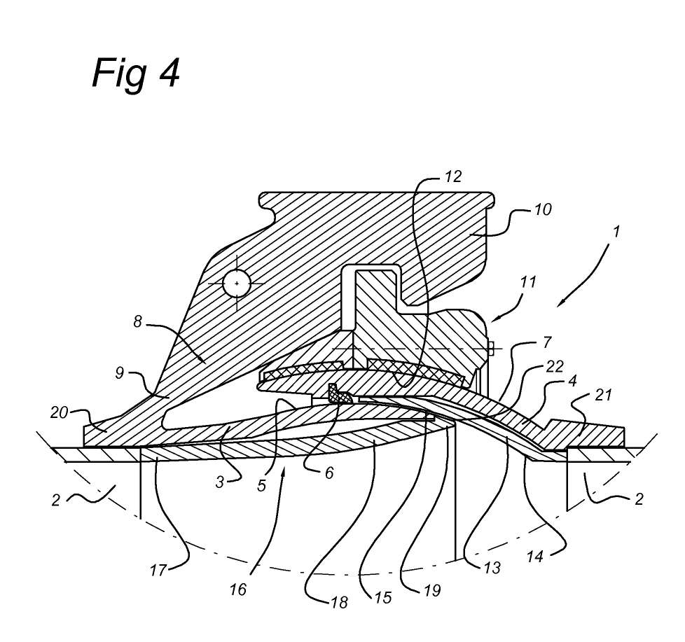

FIG. 4 shows the detail according to VI from FIG. 1 on an enlarged scale.

The pipe connection shown in FIGS. 1-4 comprises the ball joint 1 and the pipes 2 welded firmly thereto. The ball joint 1 comprises the innermost shell part 3 and the outermost shell part 4. The shell parts 3, 4 are spherical, wherein the outer surface 5 of the innermost shell part 3 is spherical, and also the outermost surface 7 of the outermost shell part 4. On the inside of the outermost shell part 4, a sealing element 6 is attached which interworks in a sealing and displaceable manner with the spherical outer surface 5 of the innermost shell part 3.

The yoke 8 is attached to the innermost shell part 3. This yoke 8 comprises an annular body 9, on which a number of jaws 10 distributed over the circumference thereof are provided. The jaws 10 interwork with the bush 11, which has an inner hollow surface 12 which has a curvature corresponding to the outer surface 7 of the outermost shell part 4, and wherein the outermost shell part 4 is rotatably held in place in a known manner.

A lining 13 is provided on the inside of the innermost shell part 3. The lining 13 has an inner hollow surface 14, the shape of which corresponds to the spherical shape of the outer surface 5 of the innermost shell part 3. A thin gap 15 is formed between these surfaces 5, 14, said gap having an essentially uniform thickness in the different rotated positions of the shell parts 3, 4 in relation to one another. As a result of the immediate proximity of the lining 13 in relation to the outer surface 5 of the innermost shell part 3, hardly any turbulence can develop in the liquid located there. As a result, that surface 5 will also hardly be touched, and the surface condition thereof will remain suitable for a prolonged period for creating an effective seal with the sealing element 6.

For further improvement of the durability of the pipe connection, a flow guide 16 is provided on the inside of the innermost shell part 3. This flow guide extends from the sleeve 20 of the ring 9 to which the one pipe piece 2 is welded to near the inner surface 14 of the lining 13. Near the inner surface 14, the flow guide 16 changes into a nozzle 19 which lies close up to the surface 14, forming a gap 22. This gap 22 between the nozzle 19 and the lining 13 has a dimension which is roughly as great as that of the gap 15 between the lining 13 and the innermost shell part 3. The flow guide promotes a regular flow of the medium fed through the pipe connection, in such a way that as little turbulence as possible occurs therein. In this context, the flow guide preferably has an essentially cylindrical part 17 close to the sleeve 21, which changes into a part 18 which widens in the form of a trumpet and ends in the nozzle 19.

### LIST OF REFERENCE NUMBERS

1. Ball joint
2. Pipe
3. Innermost shell part
4. Outermost shell part
5. Outer surface of innermost shell part
6. Sealing element
7. Outer surface of outermost shell part
8. Yoke
9. Ring
10. Jaw
11. Bush
12. Inner surface of bush
13. Lining
14. Inner surface of lining
15. Gap between lining and inner shell part
16. Flow guide
17. Cylindrical part of flow guide
18. Trumpet-shaped part of flow guide
19. Nozzle of flow guide
20. Sleeve
21. Sleeve
22. Gap between nozzle and lining

1-16. (canceled)

17. Pipe connection, comprising a ball joint (1) having shell parts (3, 4) surrounding one another in a sealing manner which each define a respective longitudinal centre line and which are rotatable in relation to one another between an aligned position, in which the longitudinal centre lines coincide, and a rotated position, in which the longitudinal centre lines form an angle with one another which differs from zero, wherein the shell parts together enclose an axial passage which extends between the ends of the shell parts (3, 4) facing away from one another, as well as a yoke (8) attached to the innermost shell part (3), said yoke being provided with a bush (11) with an inner spherical surface (12) which interworks in the manner of a ball and socket joint with an outer spherical surface (7) of the outermost shell part (4) characterized in that in the outermost shell part (4), a lining (13) is provided, the inner lining surface (14) of which has a curvature corresponding to the curvature of the outer surface (5) of the inner shell part (3), in that the lining surface (14) and the outer surface (5) of the inner shell part (3) lie entirely free in relation to one another and in that a sealing element (6) connected to the outermost shell part and interworking displaceably with the outer surface of the innermost shell part is provided, wherein the lining (13) extends between the sealing element (6) and the sleeve (21) of the outermost shell part (4).

18. Pipe connection according to claim 17, wherein the lining surface (14) and the outer surface (5) of the inner shell part (3) enclose a gap (15) with an essentially uniform thickness.

19. Pipe connection according to claim 17, wherein the lining surface (14) is essentially spherical.

20. Pipe connection according to claim 17, wherein a flow guide (16) is provided in the innermost shell part (3).

21. Pipe connection according to claim 20, wherein the flow guide (16) has a cylindrically and/or spherically curved inner flow guide surface (17, 18).

22. Pipe connection according to claim 20, wherein the flow guide (16) extends beyond the end of the inner shell part (3) which adjoins the lining (13).

23. Pipe connection according to claim 22, wherein the flow guide has a nozzle(19) which lies free in relation to the lining surface (14).

24. Pipe connection according to claim 23, wherein the nozzle (19) and the lining surface (14) enclose a gap (22), the size of which is essentially identical to the gap (15) between the lining surface (14) and the outer surface (5) of the inner shell part (3).

25. Pipe connection according to claim 20, wherein the flow guide (16) comprises a flow guide part (17) which is located close to the sleeve (20) of the innermost shell part (3) and which is essentially cylindrical.

26. Pipe connection according to claim 20, wherein the flow guide (16) comprises a flow guide part (18) which is located close to the outermost shell part (4) and which is designed as widening in the form of a cone or trumpet.

27. Pipe connection according to claim 20, wherein the flow guide (16) comprises a plastic material.

28. Pipe connection according to claim 16, wherein the lining comprises a plastic material (13).

29. Pipe connection provided with a ball joint (1) according to claim 16, wherein a sleeve (20), (21), to which a respective pipe piece (2) is attached, e.g. by welding, is provided in each case on the connection pieces of the shell parts (3, 4) of the ball joint (1).

30. Pipe connection according to claim 18, wherein the lining surface (14) is essentially spherical.

31. Pipe connection according to claim 18, wherein a flow guide (16) is provided in the innermost shell part (3).

32. Pipe connection according to claim 21, wherein the flow guide (16) extends beyond the end of the inner shell part (3) which adjoins the lining (13).

33. Pipe connection according to claim 21, wherein the flow guide (16) comprises a flow guide part (17) which is located close to the sleeve (20) of the innermost shell part (3) and which is essentially cylindrical.

34. Pipe connection according to claim 22, wherein the flow guide (16) comprises a flow guide part (17) which is located close to the sleeve (20) of the innermost shell part (3) and which is essentially cylindrical.

35. Pipe connection according to claim 23, wherein the flow guide (16) comprises a flow guide part (17) which is located close to the sleeve (20) of the innermost shell part (3) and which is essentially cylindrical.

36. Pipe connection according to claim 24, wherein the flow guide (16) comprises a flow guide part (17) which is located close to the sleeve (20) of the innermost shell part (3) and which is essentially cylindrical.
